(19) United States
(12) Patent Application Publication
(10) Pub. No.: US 2012/0072942 A1
(43) Pub. Date: Mar. 22, 2012

(54) BROADCAST-CONTENTS MANAGEMENT APPARATUS AND CONTROL METHOD FOR USE IN A BROADCAST-CONTENTS MANAGEMENT APPARATUS

(76) Inventors: Naoko SATOH, Hachioji-shi (JP); Toshiki MORI, Kodaira-shi (JP); Shuichi YAMAGUCHI, Kunitachi-shi (JP)

(21) Appl. No.: 13/197,543

(22) Filed: Aug. 3, 2011

(30) Foreign Application Priority Data
Sep. 17, 2010 (JP) 2010-209324

(51) Int. Cl. H04N 21/24

(52) U.S. Cl. 725/14

(57) ABSTRACT

According to one embodiment, a broadcast-contents management apparatus includes a plurality of network interface modules, a plurality of storage modules and a controller. The plurality of network interface modules connect with an information processing apparatus including functions relating to process on contents data. The plurality of storage modules store the contents data sent from the information processing apparatus. The controller monitors or controls the plurality of network interface modules and the plurality of storage modules. The controller includes a selector. The selector selects a combination of a network interface module and a storage module to use, based on use statuses of the plurality of network interface modules and the plurality of storage modules or based on a preset condition, when the controller performs process on the contents data. The selector performs the process on contents data by the selected combination.

### CROSS-REFERENCE TO RELATED APPLICATIONS

This application is based upon and claims the benefit of priority from prior Japanese Patent Application No. 2010-209324, filed Sep. 17, 2010, the entire contents of which are incorporated herein by reference.

### FIELD

Embodiments described herein relate generally to a broadcast-contents management apparatus and a control method for use in a broadcast-contents management apparatus, wherein the broadcast-contents management apparatus performs distribution processing on contents for broadcast programs to be distributed, in a broadcast station.

### BACKGROUND

As is well known, in a broadcast program play-out system, distribution contents for a broadcast program are stored in advance in a video server, and a corresponding content is reproduced and toward transmitter or equipment in accordance with an instruction from a automation program control system. In such an on-air processing, conventionally, a work of checking contents is carried out in accordance with an on-air order.

The aforementioned system has a small storage capacity, and at most, only one or two video contents are simultaneously input/output. Therefore, use conditions of network interfaces are managed by a user.

In accordance with increase in capacity of a storage which comprises a plurality of storages arranged in parallel, a video server provided with a plurality of network interfaces has appeared. When a video content is captured or extracted, which resource is to be used needs to be efficiently selected.

If the number of resources increases, management becomes complex for users. As a result, a problem appears in that capture efficiency deteriorates or capture fails.

### BRIEF DESCRIPTION OF THE DRAWINGS

FIG. 1 is a block diagram showing a configuration of a broadcast program play-out system to which an embodiment is applied;

FIG. 2 is a block diagram showing a configuration of a video server according to the embodiment;

FIG. 3 is a block diagram showing a specific configuration of a control management module shown in FIG. 2;

FIG. 4 is a table showing an example of content stored in a configuration management table shown in FIG. 3;

FIG. 5 is a table showing an example of content stored in a resource management table shown in FIG. 3;

FIG. 6 is a table showing an example of content stored in the resource management table shown in FIG. 3;

FIG. 7 is a table showing an example of content stored in the resource management table shown in FIG. 3;

FIG. 8 is a table showing an example of content stored in the resource management table shown in FIG. 3;

FIG. 9 is a table showing an example of content stored in a reservation storage module shown in FIG. 3;

FIG. 10 is a timing chart showing an example of a file input sequence;

FIG. 11 is a timing chart showing an example of a forced connection sequence by a user with a high level;

FIG. 12 is a flowchart showing a processing procedure of the control management module when no resource is free;

FIG. 13 is a chart for describing an example when reproduction is interrupted halfway;

FIG. 14 is an example of an adjustment sequence between users; and

FIG. 15 is a timing chart showing an example of a reservation sequence.

### DETAILED DESCRIPTION

Hereinafter, an embodiment will be described with reference to the drawings.

In general, according to one embodiment, a broadcast-contents management apparatus includes a plurality of network interface modules, a plurality of storage modules and a controller. The plurality of network interface modules connect with an information processing apparatus including functions relating to processing on contents data. The plurality of storage modules store the contents data sent from the information processing apparatus. The controller monitors or controls the plurality of network interface modules and the plurality of storage modules. The controller includes a selector. The selector selects a combination of a network interface module and a storage module to use, based on use statuses of the plurality of network interface modules and the plurality of storage modules or based on a preset condition, when the controller performs process on the contents data. The selector performs the process on contents data by the selected combination.

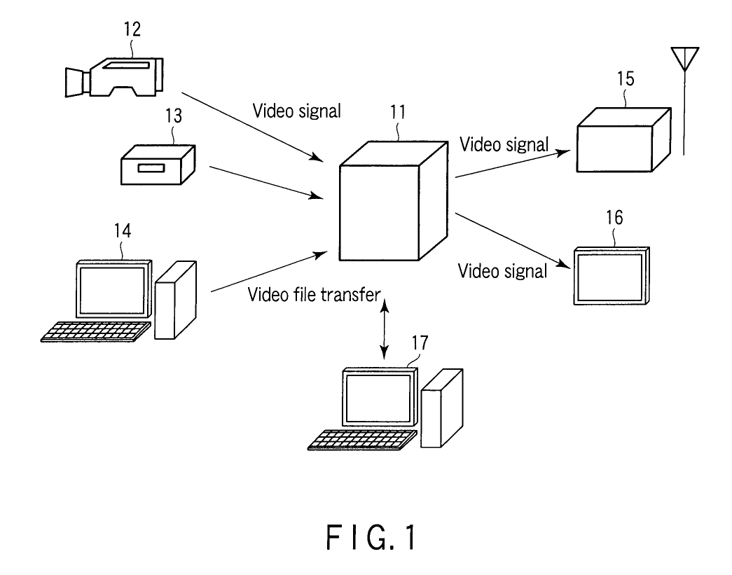

FIG. 1 is a block diagram showing a configuration of a broadcast-program play-out system to which the embodiment is applied. In FIG. 1, a reference symbol 11 denotes a video server which stores contents data (e.g., video data in this embodiment) for broadcast programs to be put on air from a camera 12, a reproduction deck 13, and a non-linear editor 14, and selectively reproduces corresponding video data in accordance with an on-air instruction. The reproduced data is decoded into a video signal in the video server 11 is introduced to a broadcast installation 15. The video signal towards transmitter or equipment as needed. Further, a video signal reproduced from the video server 11 is supplied to a monitor 16.

On the other side, the video server 11 performs a write/read control in accordance with an operation input instruction through an operation terminal 17.

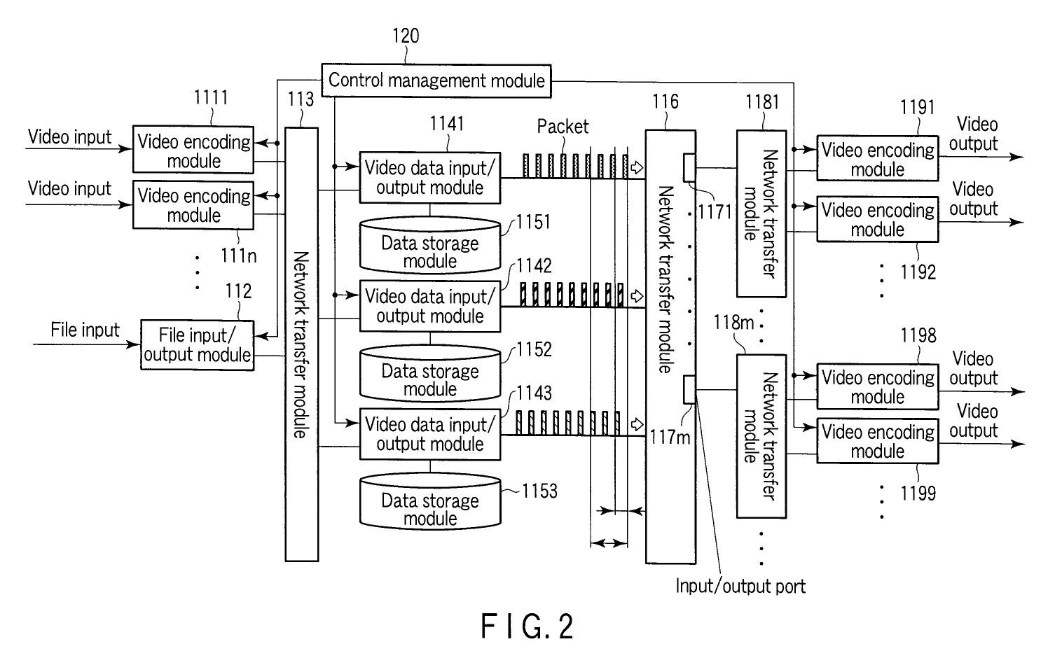

FIG. 2 is a circuit block diagram showing a configuration of the video server 11 according to the embodiment.

The video server 11 comprises: a plurality of video encoding modules 1111 to 111n as network interface modules which encode a video input as a video signal in a HD (High Definition)-SDI (Serial digital Interface) format, into an encode format such as MPEG2 (Moving Picture Experts Group 2); a file input/output module 112 which accepts encoded input in a file format; network transfer modules 113, 116, and 1181 to 118m which transfer encoded video data; data storage modules 1151 to 1153; video-data input/output modules 1141 and 1143 as senders signal processing modules which input/output the video data transferred through the network, to/from the data storage modules 1151 to 1153; a plurality of video decoding modules 1191 to 1199 as network interface modules which, as receivers' signal processing modules, decode the video data from the video-data input/output modules 1141 to 1143; and a control management module 120 which performs timing synchronization between the video-data input/output modules 1141 to 1143 and distribution control of video data.

Among the aforementioned modules, the network transfer module 116 is provided with output buffers 1171 to 117m corresponding in number to output ports.

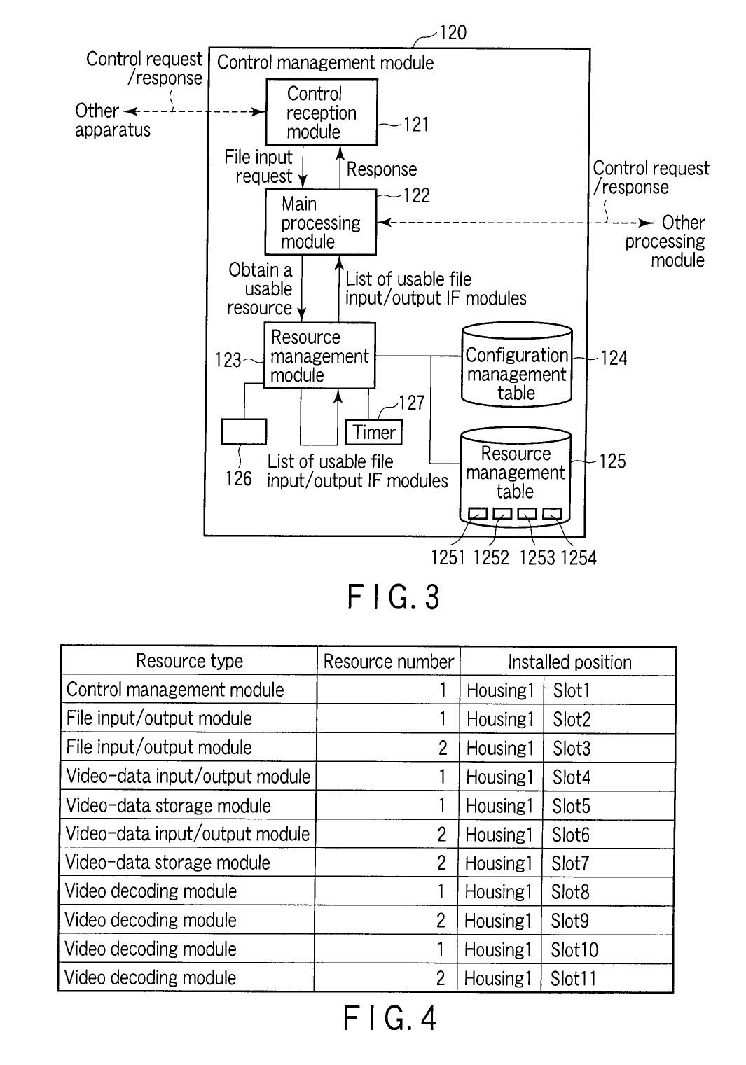

FIG. 3 is a block diagram showing a specific configuration of the control management module 120.

In the control management module 120 described above, a control reception module 121 receives a control request from one other apparatus. The aforementioned other apparatus is an operation terminal, a contents server or an operation terminal thereof, or a non-linear editor. A type of a received command is determined by a main processing module 122. If the command is a file input request or file output request, the control reception module 121 requests a usable resource from a resource management module 123.

The resource management module 123 determines a free file input/output interface module from a configuration management table 124 and a resource management table 125, and returns a list to the main control module 122. The main control module 122 prepares and returns a response message to a apparatus as a request source through the control reception module 121.

Thereafter, the aforementioned other apparatus obtains information (IP address, information required for connection, etc.) of a file input/output interface module as a connection destination from a response message, makes connection, and inputs/outputs a file.

As shown in FIG. 4, the configuration management table 124 stores data expressing correspondence relationships between resource types, resource numbers, and equipment positions in a housing, wherein the resource types are the video encoding modules 1111 to 111n, a file input/output IF module 112, data storage modules 1151 to 1153, video-data input/output modules 1141 to 1143, video encoding modules 1191 to 1199, and control management module 120.

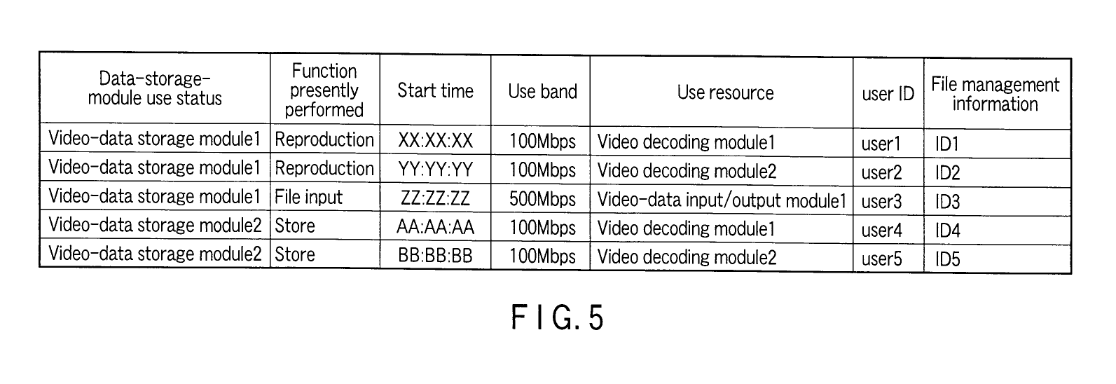

Further, the resource management table 125 is provided with tables 1251, 1252, 1253, and 1254. As shown in FIG. 5, the table 1251 stores data expressing correspondence relationships between functions presently preformed, start-time bands, resources presently used, requested user IDs, and file IDs.

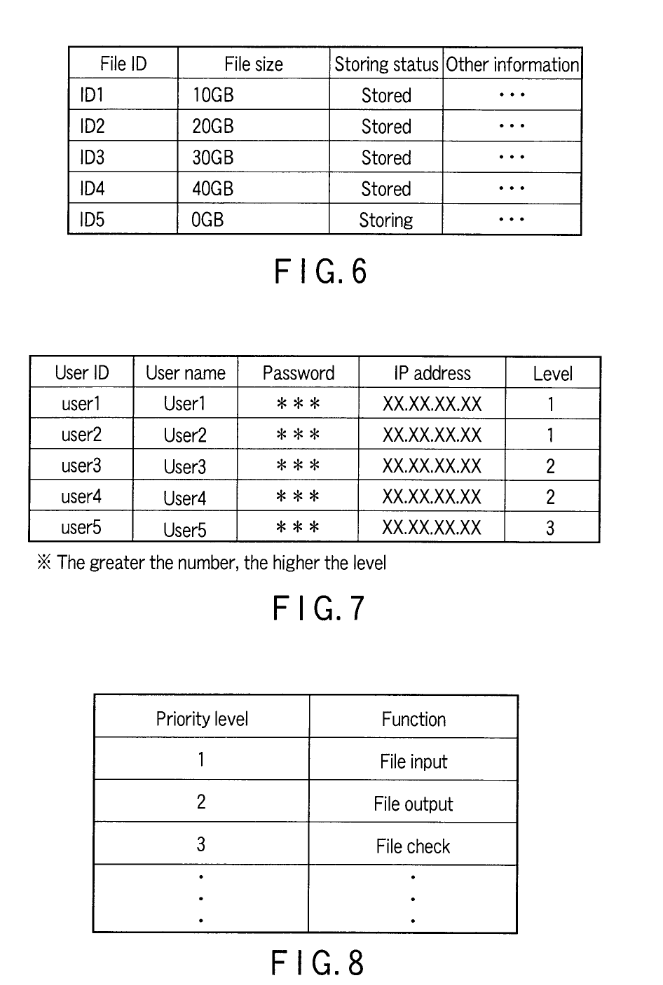

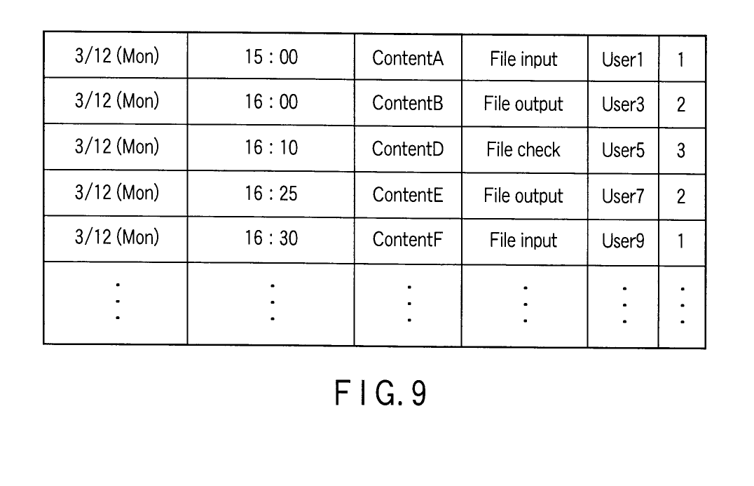

As shown in FIG. 6, the table 1252 stores data expressing correspondence relationships between file IDs, file sizes, and recorded states. As shown in FIG. 7, the table 1253 describes data expressing correspondence relationships between user names, passwords, IP (Internet Protocol) addresses, and operator levels assigned to users, respectively for user IDs.

As shown in FIG. 8, the table 1254 stores data expressing correspondence relationships between priority levels and identification information of functions. The aforementioned functions are a file input function, a file output function, and a file check function. The file check function is to check whether a recorded file is proper or not, by a hash value check. Further, the file check function is to read and check data in a memory by using the network interface module, like file output.

The resource management module 123 stores/retains reservation data into a reservation-information storage module 126 when an input request for inputting reservation data comes from one other apparatus. Reservation data stored in the reservation-information storage module 126 is data expressing correspondence relationships between processing execution dates counted by a timer 127, times, identification information of contents, function identification information, user IDs, and priority information.

Next, operation of the configuration described above will be described.

(File Input Request Processing)

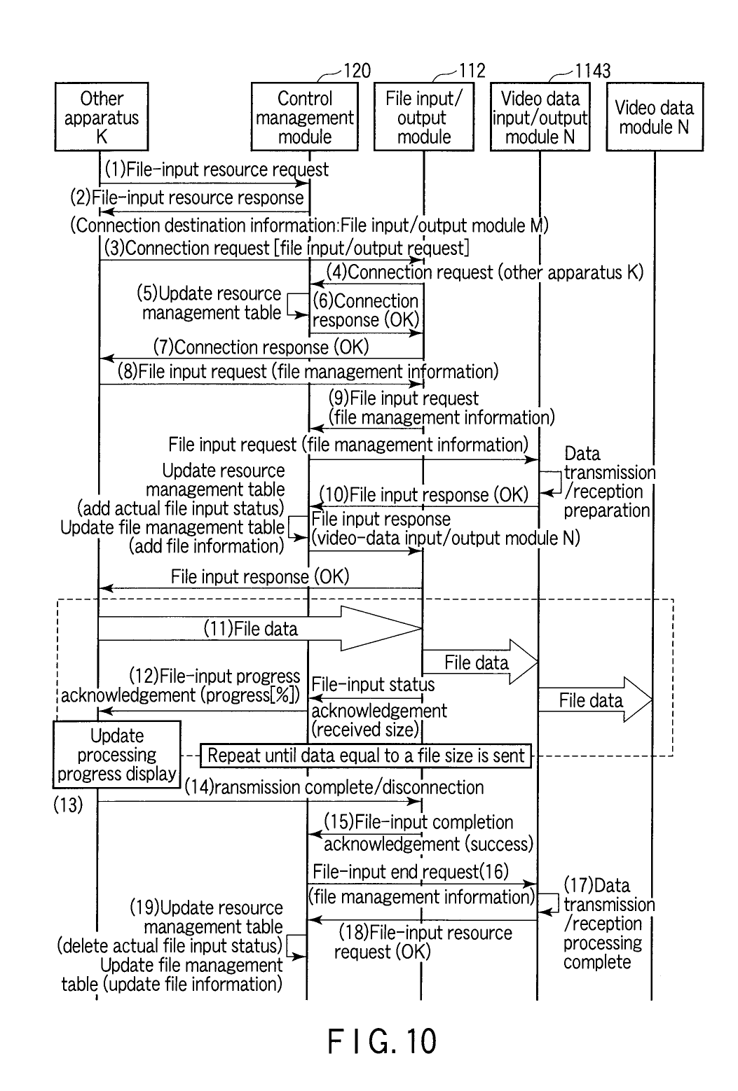

FIG. 10 shows an example of a file input sequence. When a file input resource request is received from one other apparatus K (FIG. 10(1)), information the table 1251 in the resource management table 125 is referred to, and information (IP address) of a connectable file input/output interface is returned to the aforementioned other apparatus (FIG. 10(2)). This information may be in a list format. When a DNS server is used, a corresponding part of process is replaced in accordance with a DNS protocol. The aforementioned other apparatus K may be an operation terminal of a video play-out system, a contents server or an operation terminal thereof, or a non-linear editor.

Based on the information, the aforementioned other apparatus K makes connection with the file input/output IF module 112 (FIG. 10(3)). Either an original command or an existing protocol such as FTP connection may be used. Although the apparatus K is supposed to directly input/output a file, a apparatus which asks a resource and a apparatus which actually inputs/outputs a file need not be the same as each other (for example, when a contents server and an operation terminal are separate). The file input/output module 112 informs the control management module 120 of that there has been a connection request (FIG. 10(4)). The control management module 120 checks the resource management table 125. If there is a connectable video-data input/output module (which is combined with a video data module), the control management module 120 updates the resource management table 125 (FIG. 10(5)) and replies with an OK response (FIG. 10(6)). The file input/output module 112 replies with a response to the apparatus K (FIG. 10(7)). Otherwise, if there is no free resource, i.e., in case of an NG response, the session is disconnected and terminated.

When a resource is retained, the aforementioned other apparatus K issues a file input request (or a file output request) (FIG. 10(8)).

Described now will be a case of a file input request. When a file input request reaches the file input/output module 112, the file input/output module 112 transfers the file input request to the control management module 120 (FIG. 10(9)). If the control management module 120 can retain a resource, the file input/output module 112 replies with an OK response to the file input request (FIG. 10(10)). Thereafter, the control management module 120 writes actual file data into a video data module N through the file input/output IF module 112 (FIG. 10(11)).

Each time when one data reception processing succeeds, the file input/output IF module 112 sends a file-input status acknowledgement to the control management module. The control management module 120 calculates a progress by (received size/whole file size)*100, and sends a file-input progress acknowledgement to the aforementioned other apparatus K (FIG. 10(12)). The aforementioned other apparatus K updates a processing progress display upon receiving the acknowledgement (FIG. 10(13)).

When distribution of the file data is complete, the aforementioned other apparatus K acknowledges the file input/output IF module 112 of completion of distribution, and disconnects from the control management module 120 (FIG. 10(14)). The file input/output IF module 112 acknowledges the control management module 120 of completion of file input (FIG. 10(15)). The control management module 120 transmits a termination request for terminating the file input to the video-data input/output module 1143 (FIG. 10(16)). When the video-data input/output module 1143 receives a termination request from the control management module 120, the video-data input/output module 1143 then completes the data transmission/reception processing (FIG. 10(17)), and replies with a termination response for terminating file input to the control management module 120 (FIG. 10(18)).

Thereafter, the control management module 120 performs a post processing of deleting the file input processing from the table 1252 in the resource management table 125, and changing a status of a recorded file on a file management table, and terminates the file input sequence (FIG. 10(19)).

(Forced Connection Processing)

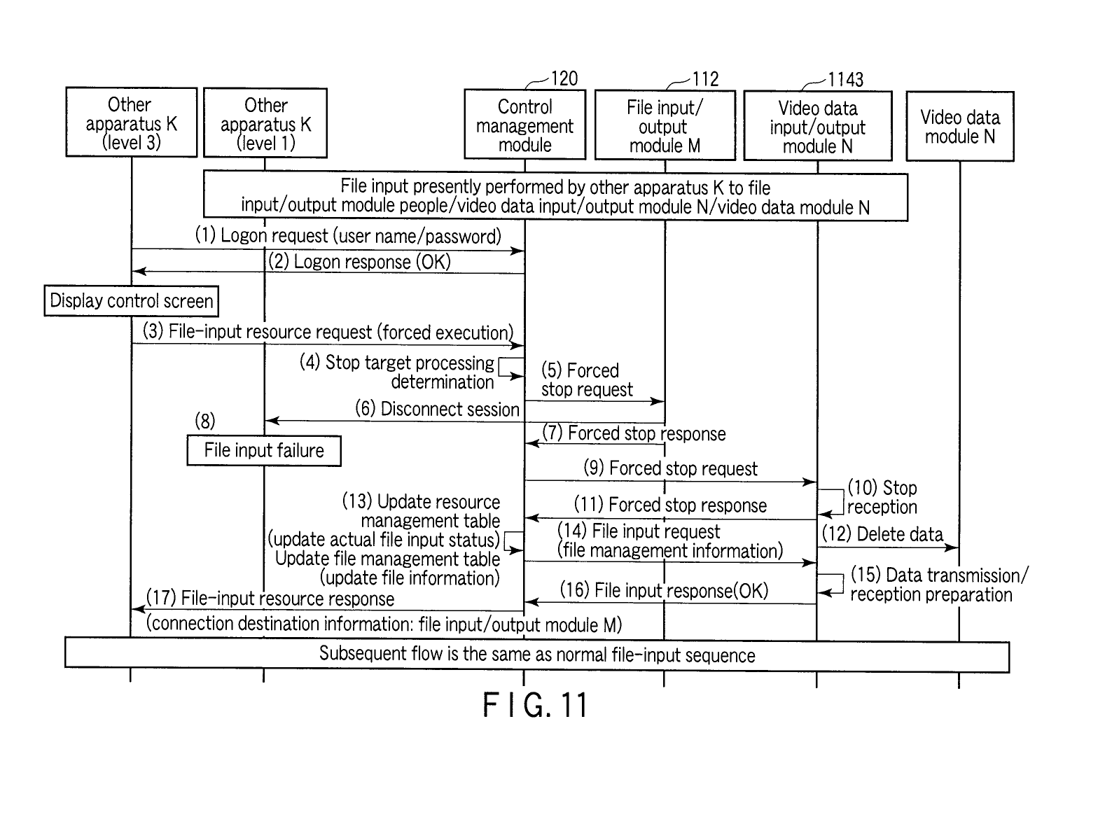

FIG. 11 is an example of a forced connection sequence.

If there is no free resource, a user of one other apparatus L can forcibly stop a processing presently performed by another user assigned with a lower priority level than the user of the aforementioned other apparatus L, and perform the file input/output processing, by specifying “forced execution” through an input module (unillustrated) at the time of requesting a file input resource.

If a log-on processing is performed in advance, the control management module 120 can determine a level for each user who logs in.

Here, the file input processing is supposed to be performed between the aforementioned other apparatus K, control management module 120, file input/output module 112, and video-data input/output module 1143.

For example, the user of the aforementioned other apparatus L assigned with a higher priority level than the aforementioned other apparatus K accesses the control management module 120. Further, the user of the apparatus L inputs a user ID and a password from a log-on screen, to try log-on the control management module 120. Upon completion of inputting the ID and password, the apparatus L transmits a log-on request including the user ID and password to the control management module 120 (FIG. 11(1)).

The control management module 120 which has received the log-on request from the aforementioned other apparatus L checks whether the user ID corresponds to any of a group of IDs registered in the table 1253 in the resource management table 125 or not. If not, the control management module 120 does not allow logon but replies to the apparatus L with an error message indicating absence of a corresponding user name.

Otherwise, if the ID is OK, the control management module 120 authenticates the password. If the password is wrong, the control management module 120 replies with an error message thereof.

On the other side, if all checks are OK, the control management module 120 replies to the aforementioned other apparatus L with a log-on response as a message indicating completion of authentication (FIG. 11(2)).

Further, the user of the aforementioned other apparatus L is supposed to request the control management module 120 to perform file input. Then, the apparatus L transmits a file-input resource request to the control management module 120 (FIG. 11(3)). When the control management module 120 receives a file input resource request (forced execution) from the apparatus L, whether there is a processing as a target to stop or not among presently performed processing is determined from the resource management table 125 and the user management table (FIG. 11(4)). If there is a processing as a target to stop, the control management module 120 transmits a forced stop request, for example, to the file input/output module 112 (FIG. 11(5)).

When the forced stop request comes, the file input/output module 112 disconnects a session with the aforementioned other apparatus K (FIG. 11(6)), and replies to the control management module 120 with the forced stop request (FIG. 11(7)). Then, the apparatus K fails input (FIG. 11(8)). Further, the control management module 120 transmits the forced stop request to the video-data input/output module 1143 (FIG. 11(9)). When the video-data input/output module 1143 receives the forced stop request from the control management module 120, the video-data input/output module 1143 stops receiving video data and replies to the control management module 120 with a forced stop response (FIG. 11(11)). Further, the video-data input/output module 1143 deletes data which is written halfway the video data module N (FIG. 11(12)).

Thereafter, the control management module 120 updates the resource management table 125 and file management table (FIG. 11(13)), and transmits a file input request to the video-data input/output module 1143 (FIG. 11(14)). Upon completion of preparation for data transmission/reception, the video-data input/output module 1143 replies to the control management module 120 with a file input response (FIG. 11(16)). Then, the control management module 120 replies to the aforementioned other apparatus L that a resource is retained (FIG. 11(17)). Subsequent processes are the same as those of the file input sequence.

(Forced Connection Processing Based on Priority Levels of Functions)

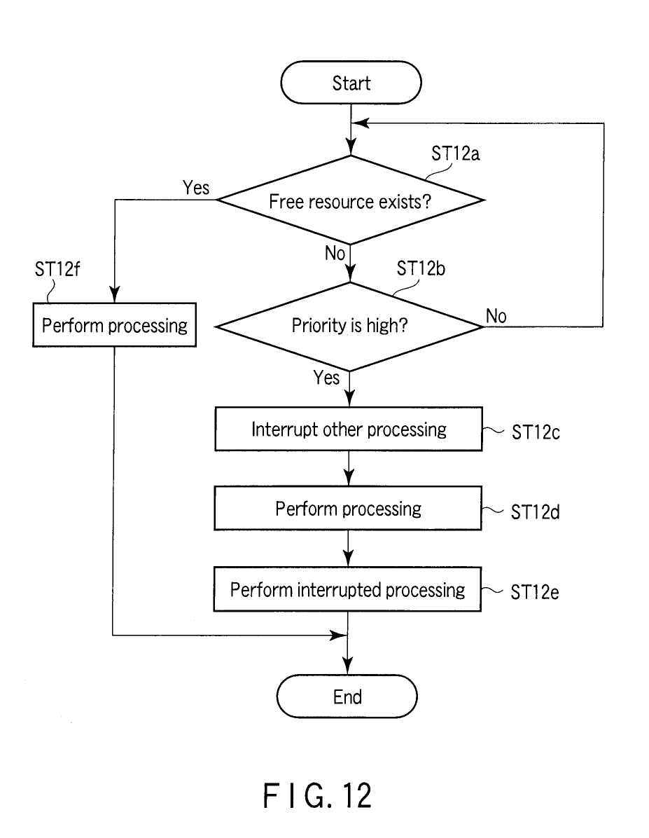

FIG. 12 is a flowchart showing a processing procedure of the control management module 120 described above when there is no free resource.

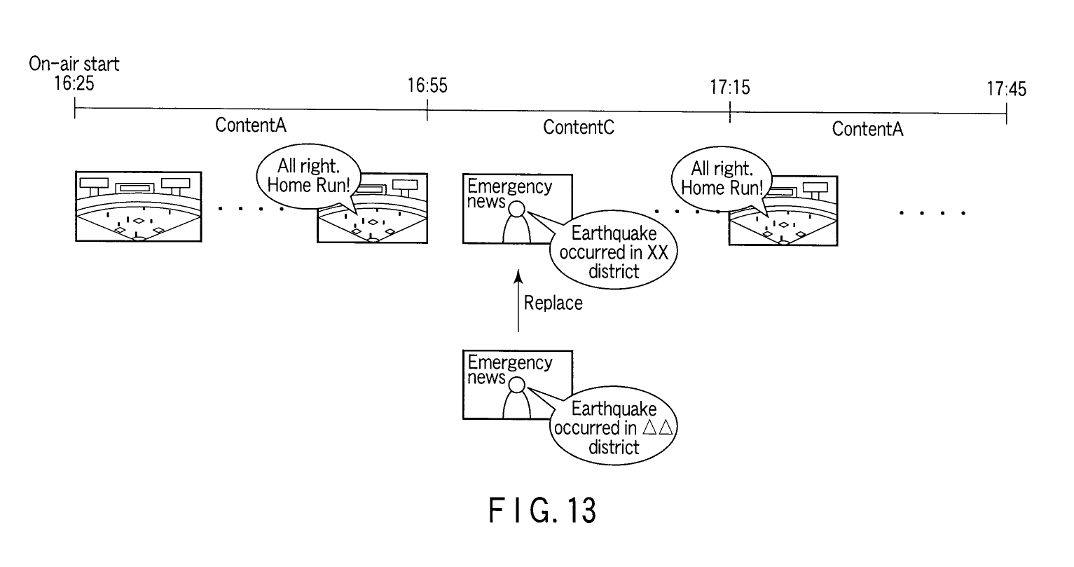

As shown in FIG. 13, the video-data input/output module 1141 is now supposed to perform file input for a baseball program (content A) at 16:25, where on-air of the baseball program is to start at 16:30. File input for this content A continues from 16:30 to 17:30.

While the content A is subjected to file input to the video-data input/output module 1141, for example, a request for performing file input for an emergency news program (content C) which reports earthquake information is supposed to reach the control management module 120 from the aforementioned other apparatus K. Then, the control management module 120 determines whether there is a free resource or not (step ST12a), by referring to the resource management table 125 (step ST12a). If there is no free resource (No), the control management module 120 further determines whether on-air of the emergency news program is assigned with a higher priority level than that of file output or not (step ST12b).

Since a priority level of file input for the emergency news program is “1” and a priority level of file output is “2”, the control management module 120 interrupts a file input processing for the content A (step ST12c), and makes the video-data input/output module 1141 perform file input for the emergency news program (content C) (step ST12d). At this time, as shown in FIG. 13, the content C reporting “Earthquake occurred in XX district” is wrong and therefore replaced with a content D reporting “Earthquake occurred in □□ district”.

Further, when file input for the emergency news program (content D) ends, the control management module 120 then controls the video-data input/output module 1141 (step ST12e) so as to restart a file input processing for the content A from a position where the content A ends at 16:55 (step ST12e).

In the foregoing step ST12a, the control management module 120 performs a file output processing for the content A when there is a free resource, and performs file input for the emergency news program (content C) by use of a free video-data input/output module 1142 (step ST12f).

(Adjustment)

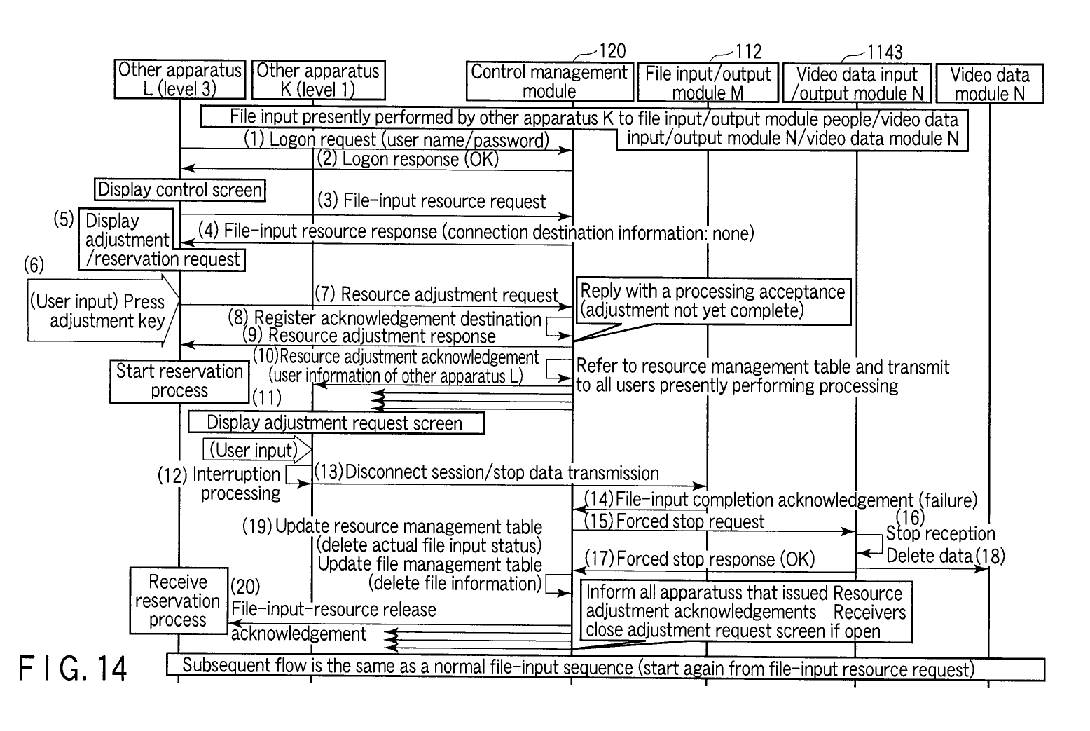

FIG. 14 shows an example of adjustment sequence among users.

A file input processing is now supposed to be presently performed between one other apparatus K, the control management module 120, file input/output module 112, and video-data input/output module 1143.

For example, the user of one other apparatus L which is assigned with a higher priority level than the aforementioned other apparatus K accesses the control management module 120. Further, the user of the aforementioned other apparatus L inputs a user ID and a password from a log-on screen, to try log-on the control management module 120. Upon completion of inputting the ID and password, the apparatus L transmits a log-on request including the user ID and password to the control management module 120 (FIG. 14(1)).

The control management module 120 which has received the log-on request from the apparatus L checks whether the user ID corresponds to any of a group of IDs registered in the table 1253 in the resource management table 125 or not. If the ID is OK, the control management module 120 authenticates the password. If all checks are OK, the control management module 120 replies to the apparatus L with a log-on response as a message indicating completion of authentication (FIG. 14(2)).

Further, the user of the apparatus L is supposed to request the control management module 120 to perform file input. Then, the apparatus L transmits a file input resource request to the control management module 120 (FIG. 14(3)).

If the file input resource request fails (FIG. 14(4)), “adjustment/reservation request screen” is displayed on the control screen of the apparatus L (FIG. 14(5)). An adjustment key and a reservation key exist on that screen. If the adjustment key is pressed (FIG. 14(6)), a resource adjustment request is sent to the control management module 120 from the apparatus L (FIG. 14(7)).

Upon receiving the resource adjustment request, the control management module 120 refers to the resource management table 125 and determines whether there is a apparatus presently performing a processing or not (FIG. 14(8)), and replies to the apparatus L with a resource adjustment response (FIG. 14(9)), and transmits a resource adjustment acknowledgement added with information of the user who just requested the adjustment, to all apparatuses presently performing processes (FIG. 14(10)).

A apparatus which has received the resource adjustment acknowledgement displays that an adjustment request has arrived (FIG. 14(12)), and transmits a message indicative of session disconnection/data transmission stop to the file input/output module 112 (FIG. 14(13)).

Upon receiving the foregoing message, the file input/output module 112 informs the control management module 120 of completion of file input (FIG. 14(14)). Then, the file input/output module 112 fails input. The control management module 120 transmits a forced stop request to the video-data input/output module 1143 (FIG. 14(15)). Upon receiving the forced stop request from the control management module 120, the video-data input/output module 1143 stops receiving video data (FIG. 14(16)), and replies to the control management module 120 with a forced stop response (FIG. 14(17)). The video-data input/output module 1143 deletes data which has been halfway written into the video data module N (FIG. 14(18)). In this manner, a resource is released.

Thereafter, the control management module 120 updates the resource management table 125 and file management table (FIG. 14(19)). When a resource is released, the control management module 120 transmits a resource release acknowledgement to a request source and all acknowledgement destinations (FIG. 14(20)).

At the request source, a reservation process has already started at the same time when the request has started. Upon receiving the acknowledgement, adjustment is started again from a file input resource request.

(Reservation Processing)

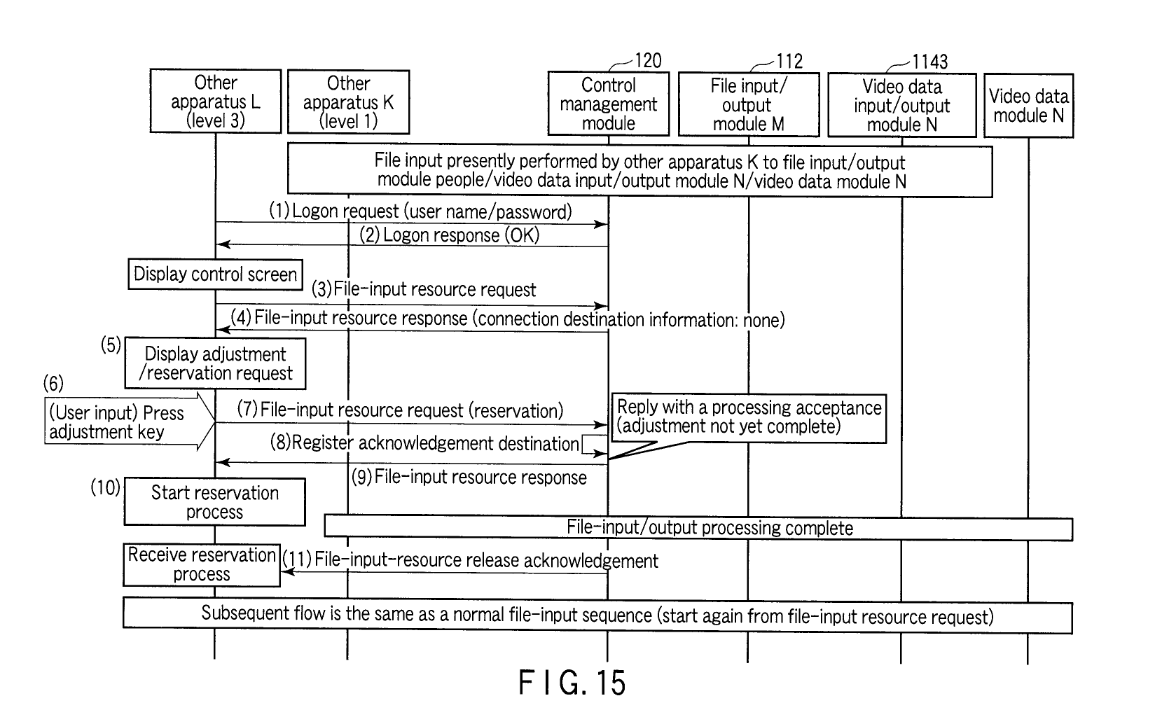

FIG. 15 is an example of a reservation sequence.

A file input processing is now supposed to be presently performed between one other apparatus K, the control management module 120, file input/output module 112, and video-data input/output module 1143.

For example, the user of one other apparatus L which is assigned with a higher priority level than the aforementioned other apparatus K accesses the control management module 120. Further, the user of the aforementioned other apparatus L inputs a user ID and a password from a log-on screen, to try log-on the control management module 120. Upon completion of inputting the ID and password, the apparatus L transmits a log-on request including the user ID and password to the control management module 120 (FIG. 15(1)).

The control management module 120 which has received the logon request from the apparatus L checks whether the user ID corresponds to any of a group of IDs registered in the table 1253 in the resource management table 125 or not. If the ID is OK, the control management module 120 authenticates the password.

If all checks are OK, the control management module 120 replies to the apparatus L with a log-on response as a message indicating completion of authentication (FIG. 15(2)).

Further, the user of the apparatus L is supposed to carry out an operation for requesting the control management module 120 to perform file input. Then, the apparatus L transmits a file-input resource request to the control management module 120 (FIG. 15(3)).

If the file input resource request fails (FIG. 15(4)), an “adjustment/reservation request screen” is displayed on the control screen of the apparatus L (FIG. 15(5)). An adjustment key and a reservation key exist on that screen. If the adjustment key is pressed (FIG. 15(6)), a file-input resource request (reservation) is sent to the control management module 120 from the apparatus L (FIG. 15(7)). The file-input resource request includes a date, time, a content name, and identification information of a function.

The control management module 120 adds received reservation data to a reservation list in the reservation-information storage module 126 (FIG. 15(8)). Further, the control management module 120 replies with a file-input resource response to the apparatus L as a request source (FIG. 15(9)). Then, the apparatus L starts a reservation processing (FIG. 15(10)).

If a processing presently performed is completed and a resource is released, the control management module 120 sends a file-input-resource release acknowledgement to an address registered as an acknowledgement destination (FIG. 15(11)).

The adjustment request source has already started a reservation process at the same time when a reservation has started. Upon receiving the acknowledgement, the reservation is started again from the file input resource request.

As described above, according to the embodiment, modules to use are automatically selected respectively from the video encoding modules 1111 to 111n, file input/output module 112, data storage modules 1151 to 1153, video-data input/output modules 1141 to 1143, and video decoding module 1191 to 1199 when video data is processed. Therefore, efficiency of capturing video data can be improved by automating operations which are automatable.

In the above embodiment, when a processing request issues for putting an emergency program on air, which is assigned with a higher priority level, file output of video data can be interrupted, and file input for the emergency program assigned with the higher priority level can be performed with priority. Accordingly, there is provided a system which achieves both processing for different functions and efficient operation from an operator.

Further, in the above embodiment, a processing of content data is reserved when no usable module exists among video coding modules 1111 to 111n, file input/output module 112, data storage modules 1151 to 1153, or video-data input/output modules 1141 to 1143. Therefore, when the video encoding module 1191 becomes free, processes from selection of the free video encoding module 1191 and the data storage module 1151 to a process of video data are automatically performed, based on reservation data thereof. The efficiency of capturing video data can be thereby improved.

Further, a DNS server may be used to inform of an acknowledgement of a list of usable network interface modules. That is, since the DNS server is provided on a network, it is possible to inform of a list of usable network interface modules with ease by using a DNS server.

### Other Embodiments

In the above embodiment, the control management module 120 may inform of a list of usable video encoding modules 1111 to 111n, file input/output module 112, data storage modules 1151 to 1153, video-data input/output modules 1141 to 1143, and video decoding modules 1191 to 1199. Further, this list may be added with use statuses, using users, and expected end time of use for the video encoding modules 1111 to 111n, file input/output module 112, data storage modules 1151 to 1153, video decoding modules 1141 to 1143, and video decoding modules 1191 to 1199. A user may be allowed to select modules.

In this manner, which of the video encoding modules 1111 to 111n, file input/output module 112, data storage modules 1151 to 1153, video-data input/output modules 1141 to 1143, and video decoding modules 1191 to 1199 are to be selected can be determined by showing a list of usable network interface modules, and use statuses, using users, and expected end time of use to users. Accordingly, actually required network interface modules and storage modules can be selected.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A broadcast-contents management apparatus comprising:
a plurality of network interface modules configured to connect with an information processing apparatus including functions relating to process on contents data;
a plurality of storage modules configured to store the contents data sent from the information processing apparatus; and
a controller configured to monitor or control the plurality of network interface modules and the plurality of storage modules, wherein
the controller comprises a selector configured to select a combination of a network interface module and a storage module to use, based on use statuses of the plurality of network interface modules and the plurality of storage modules or based on a preset condition, when the controller performs processing on the contents data, and configured to perform the processing on contents data by the selected combination.

2. The broadcast-contents management apparatus of claim 1, wherein the selector informs of a list of usable ones of the network interface modules in accordance with an instruction.

3. The broadcast-contents management apparatus of claim 2, wherein the selector informs of the list of usable ones of the network interface modules, by using a DNS server.

4. The broadcast-contents management apparatus of claim 2, wherein the selector adds information indicating a use status, a using user, and an expected end time of use, for each of the network interface modules and the storage modules, to the list of usable ones of the network interface modules, and allows users to make selection.

5. The broadcast-contents management apparatus of claim 1, wherein the controller further comprises an execution/interruption controller configured to control execution/interruption of the processing on contents data, based on a present condition, when a processing request based on a second combination issues while the process on contents data is performed based on a first combination of a network interface module and a storage module among the plurality of network interface modules and the plurality of storage modules.

6. The broadcast-contents management apparatus of claim 5, wherein the execution/interruption controller uses processing priority levels assigned respectively to the plurality of processes, to determine the condition.

7. The broadcast-contents management apparatus of claim 5, wherein the execution/interruption controller uses a level assigned a user as a request source, to determine the condition.

8. The broadcast-contents management apparatus of claim 1, wherein the selector reserves the processing on contents data if none of the plurality of network interface modules is usable.

9. A control method for use in a broadcast-contents management apparatus comprising: a plurality of network interface modules configured to connect with an information processing apparatus including functions relating to process on contents data; a plurality of storage modules configured to store the contents data sent from the information processing apparatus; and a controller configured to monitor or control the plurality of network interface modules and the plurality of storage modules, the method comprising:
selecting a combination of a network interface module and a storage module to use, based on use statuses of the plurality of network interface modules and the plurality of storage modules or based on a preset condition, when the processing on the contents data is performed; and
performing the processing on the contents data by the selected combination.
